(19) United States
(12) Patent Application Publication
(10) Pub. No.: US 2026/0319233 A1
(43) Pub. Date: Oct. 15, 2026

(54) CONFOCAL IMAGING APPARATUS AND CONFOCAL IMAGING METHOD

(71) Applicant: THE UNIVERSITY OF OSAKA, Osaka (JP)

(72) Inventors: Takeharu Nagai, Osaka (JP); Taro Ichimura, Osaka (JP); Hitoshi Hashimoto, Osaka (JP)

(73) Assignee: THE UNIVERSITY OF OSAKA, Osaka (JP)

(21) Appl. No.: 19/482,470

(22) PCT Filed: May 7, 2024
(86) PCT No.: PCT/JP2024/016941

§ 371 Date: Nov. 7, 2025

(30) Foreign Application Priority Data
May 9, 2023 (JP) 2023-077341

(51) Int. Cl. G02B 21/00; G02B 21/36

(52) U.S. Cl. CPC G02B 21/0032; G02B 21/006; G02B 21/008; G02B 21/361; G02B 21/362

(57) ABSTRACT

A confocal imaging apparatus includes: a light source configured to generate illumination light; a multi-pinhole plate being arranged at a position conjugate to the sample and having a plurality of pinholes; a drive mechanism configured to rotate the multi-pinhole plate; an objective lens configured to focus the illumination light from the multi-pinhole plate onto the sample and on which signal light from the sample is incident; a tube lens arranged between the objective lens and the multi-pinhole plate and configured to focus the signal light from the sample onto the multi-pinhole plate; a beam splitter configured to cause the signal light having passed through the pinholes to branch from the illumination light; a telecentric lens on which the signal light is incident; and an image sensor device configured to detect the signal light from the telecentric lens and to capture an image of the sample.

### TECHNICAL FIELD

The present disclosure relates to a confocal imaging apparatus and a confocal imaging method, and more specifically relates to a confocal imaging apparatus and a confocal imaging method that capture an image of a sample using a multi-pinhole plate that forms multiple focal points.

### BACKGROUND ART

Patent Literature 1 discloses a fluorescence imaging apparatus that captures fluorescence from an object to be measured using an image sensor device such as a complementary metal-oxide-semiconductor (CMOS) or a charge coupled device (CCD). The fluorescence imaging apparatus in Patent Literature 1 uses a telecentric optical system lens with a magnification of 2×.

### CITATION LIST

### Patent Literature

[Patent Literature 1] Japanese Unexamined Patent Application Publication No. 2023-3158

### SUMMARY OF INVENTION

The fluorescence imaging apparatus according to Patent Literature 1 is capable of realizing dynamic observation with subcellular-level planar (xy plane) spatial resolution within a centimeter-scale field of view (FOV). This technology is a very powerful tool and can be utilized in many applied research projects. On the other hand, the low numerical aperture (NA) of 0.12 imposes limitations on spatial resolution in an optical axis direction (z-direction) and brightness of an imaging system. To expand the possibilities for observing cell kinetics in tissues and embryos, both three-dimensional observation and improved brightness are desired.

The present disclosure has been made in consideration of the points described above and an object thereof is to provide a confocal imaging apparatus and a confocal imaging method that enable a sample to be appropriately captured over a wide field of view.

A confocal imaging apparatus according to the present embodiment includes: a light source configured to generate illumination light that illuminates a sample; a multi-pinhole plate being arranged at a position conjugate to the sample and having a plurality of pinholes through which the illumination light passes; a drive mechanism configured to drive the multi-pinhole plate so as to change an incidence position of the illumination light relative to the sample; an objective lens configured to focus the illumination light from the multi-pinhole plate onto the sample and on which signal light from the sample is incident; a tube lens arranged between the objective lens and the multi-pinhole plate and configured to focus the signal light from the sample onto the multi-pinhole plate; a beam splitter configured to cause the signal light having passed through the pinholes to branch from the illumination light directed toward the multi-pinhole plate; a telecentric lens on which the signal light caused to branch by the beam splitter is incident; and an image sensor device configured to detect the signal light from the telecentric lens and to capture an image of the sample.

In the confocal imaging apparatus described above, a background light component may be calculated by applying filter processing using a low-pass filter to image data captured by the image sensor device, and the background light component may be removed from the image data captured by the image sensor device.

In the confocal imaging apparatus described above, if f₀(x, y) denotes the image data captured by the image sensor device, curved surface data L₀(x, y) may be generated by applying processing using a low-pass filter to the image data f₀(x, y), for j an integer greater than or equal to 1, image data fⱼ(x, y) may be generated by performing iterative calculations according to equation (1) below,

[Mathematical Formula 1]

fⱼ(x, y)=min(fⱼ₋₁(x, y), Lⱼ₋₁(x, y)) (1)
image data Lⱼ(x, y) indicating the background light component may be generated by applying processing using the low-pass filter to the image data fⱼ(x, y), and the background light component may be removed by subtracting the image data Lⱼ(x, y) from the image data f₀(x, y) of the captured image.

In the confocal imaging apparatus described above, the low-pass filter may be a one-dimensional infinite impulse response filter, and the background light component may be calculated by applying the one dimensional infinite impulse response filter sequentially in the x- and y-directions.

In the confocal imaging apparatus described above, a magnification of an image of the sample formed by lens system may be 2× or lower.

In the confocal imaging apparatus described above, a diameter of the pinholes may be 15 μm or less.

A confocal imaging method according to the present embodiment includes the steps of: generating illumination light that illuminates a sample; causing the illumination light to be incident on a multi-pinhole plate disposed at a plane conjugate with the sample; focusing the illumination light having passed through a plurality of pinholes of the multi-pinhole plate onto the sample using an objective lens; causing signal light from the sample to be incident on the objective lens; focusing the signal light from the sample onto the multi-pinhole plate using a tube lens arranged between the objective lens and the multi-pinhole plate; causing the signal light having passed through the plurality of pinholes to branch from the illumination light directed toward the multi-pinhole plate using a beam splitter; focusing the signal light caused to branch by the beam splitter onto an image sensor device using a telecentric lens; driving the multi-pinhole plate so as to change an incidence position of the illumination light relative to the sample; and capturing the sample with signal light detected by the image sensor device when the multi-pinhole plate is rotated.

In the confocal imaging method described above, a background light component may be calculated by applying filter processing using a low-pass filter to image data of a captured image obtained by the image sensor device, and the background light component may be removed from the image data of the captured image.

In the confocal imaging method described above, if f₀(x, y) denotes image data of a captured image obtained by the image sensor device, curved surface data L₀(x, y) may be generated by applying processing using a low-pass filter to the image data f₀(x, y), for j an integer greater than or equal to 1, image data fⱼ(x, y) may be generated by performing iterative calculations according to equation (1) below,

[Mathematical Formula 2]

fⱼ(x, y)=min(fⱼ₋₁(x, y), Lⱼ₋₁(x, y) (1)
image data Lⱼ(x, y) indicating the background light component may be generated by applying processing using the low-pass filter to the image data fⱼ(x, y), and
the background light component may be removed by subtracting the image data Lⱼ(x, y) from the image data f₀(x, y) of the captured image.

In the confocal imaging method described above, the low-pass filter may be a one-dimensional infinite impulse response filter, and the background light component may be calculated by applying the one-dimensional infinite impulse response filter sequentially in the x- and y-directions.

In the confocal imaging method described above, a magnification of an image of the sample formed by the lens system may be 2× or lower.

In the confocal imaging method described above, a diameter of the pinholes may be 15 μm or less.

According to the present disclosure, a confocal imaging apparatus and a confocal imaging method that enable a sample to be appropriately captured over a wide field of view can be provided.

### BRIEF DESCRIPTION OF DRAWINGS

FIG. 1 is a schematic diagram showing a basic configuration of an optical system;

FIG. 2 is a diagram showing an evaluation result of a point spread function (PSF);

FIG. 3 is a diagram showing fluorescence images of cardiomyocytes and their line profiles;

FIG. 4 is a diagram showing a configuration of a confocal imaging apparatus;

FIG. 5 is a diagram showing a multi-pinhole disk;

FIG. 6 is a diagram for comparing captured images with and without a multi-pinhole disk;

FIG. 7 is a diagram showing an evaluation result of a point spread function (PSF);

FIG. 8 is a diagram showing captured images of a cavity chamber structure of a cardiac organoid;

FIG. 9 is a diagram showing images for describing background removal processing;

FIG. 10 is a schematic diagram for describing an observation method;

FIG. 11 is a diagram showing a tomographic image; and

FIG. 12 is a graph showing an imaging result.

### DESCRIPTION OF EMBODIMENTS

An embodiment to which the present invention is applicable will be described below. While the following description explains an embodiment of the present invention, note that the present invention is not limited to the following embodiment. For clarity of explanation, the following description has been omitted and simplified as appropriate. Moreover, those skilled in the art will be able to easily change, add, and convert each element of the following embodiment within the scope of the present invention. Note that the same reference numerals and characters in each drawing indicate similar elements, and the description thereof will be omitted as appropriate.

### Basic Configuration of Optical System

First, a basic configuration of an optical system developed by the inventors of the present application will be described. A wide-field imaging system (AMATERAS1.0 or AMATERAS−1) previously constructed by the inventors utilizes a 2× magnification telecentric macro lens. Dynamic observation was achieved with subcellular-level planar (xy plane) spatial resolution within a centimeter-scale field of view (FOV). Therefore, the inventors of the present application developed a giant lens system that increases the numerical aperture (NA) to 0.25 while maintaining a magnification of 2×. This lens system is constituted of an objective lens and a tube lens. The lens system has a field of view covering an image sensor size with a diagonal length of 44 mm and features aberration correction across a wavelength range of 400 nm to 700 nm. In addition, the objective lens of the lens system has a length of 310 mm and a diameter of 144 mm. The tube lens of the lens system has a length of 345 mm and a diameter of 170 mm.

The two primary metrics for evaluating the ratio of FOV to spatial resolution of the lens system-an optical invariant and a spatial bandwidth product—are 2.75 and 4.3×10⁸, respectively. The use of a CMOS sensor with a diagonal length of 35 mm in the present system results in effective values for the metrics of 2.19 and 2.8×10⁸, respectively, which are both higher values than those published for wide-field microscopes. The values are significantly higher than those of commercially available microscope lenses and microscope lenses for machine vision.

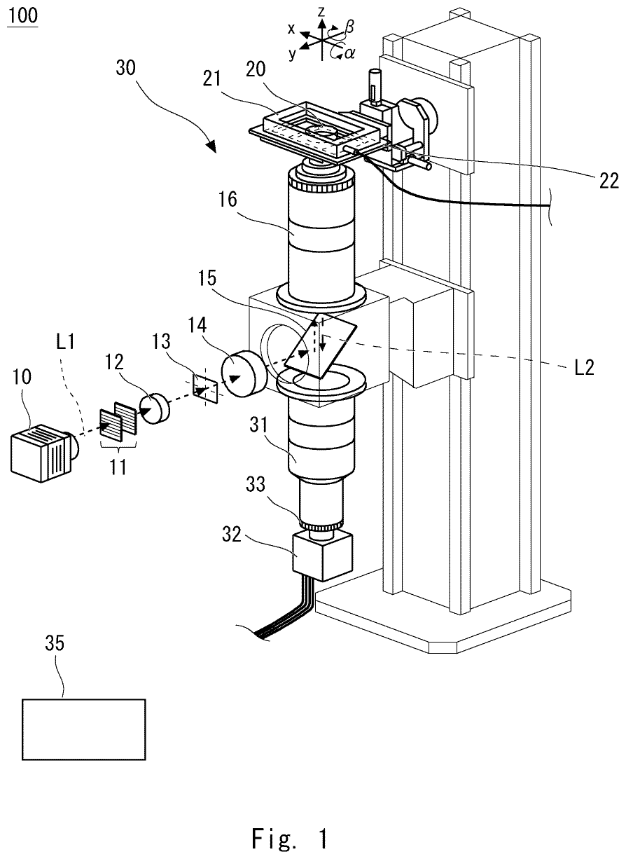

An epifluorescence imaging system constructed using this lens system will be described using FIG. 1. FIG. 1 is a diagram schematically showing a configuration of an imaging apparatus 100. In the following description, an optical axis direction of an optical system is defined as a z-direction, and an xy plane is defined as a plane perpendicular to the z-axis. An x-direction, a y-direction, and the z-direction are mutually orthogonal directions. The imaging apparatus 100 uses a lens system 30 constituted of an objective lens 16 and as tube lens 31 to form an image of a sample 20 on a camera 32.

The camera 32 is an image sensor device such as a CMOS sensor or a CCD sensor and captures the sample 20. As the camera 32, either a 120-megapixel camera (VCC-120CXP1M, CIS Corporation) or a 250-megapixel camera (VCC-250CXP1M, CIS Corporation) can be used. The two cameras are selected according to objectives of research. Both cameras have a diagonal length of 35 mm, resulting in a field of view with a diagonal length of approximately 17.8 mm. Pixel sizes are 2.2 μm and 1.5 μm, respectively. Sampling intervals at a magnification of 2× are 1.1 μm and 0.75 μm, respectively. Image data from the camera 32 is loaded to a processing apparatus 35 via a CoaXpress frame grabber board (APX-3664G3, Avaldata Corporation). The processing apparatus 35 is a work station including a processor, a memory, and a display.

A light source 10 is a high-brightness light emitting diode (LED) that generates illumination light L1 radiated toward the sample 20. For example, the light source 10 is SOLIS-470C manufactured by Thorlabs, Inc. and generates light with a wavelength of 470 nm. L1 from the light source 10 acts as excitation light that excites the sample 20. The illumination light L1 from the light source 10 is incident on a homogenizing optical system 11. The homogenizing optical system 11 has a fly-eye lens pair for uniformly illuminating the entire field of view. The homogenizing optical system 11 homogenizes a spatial distribution of the illumination light L1 on the sample 20 on the xy plane.

Illumination light L1 from the homogenizing optical system 11 is incident on a dichroic mirror 15 via a lens 14. Note that a conjugate surface 13 that is conjugate to the sample 20 is arranged between the homogenizing optical system 11 and the lens 14. The dichroic mirror 15 reflects the illumination light L1 incident from the side upward toward the objective lens 16.

The dichroic mirror 15 acts as a beam splitter that causes light to branch according to wavelength. The light reflected by the dichroic mirror 15 is incident on the objective lens 16. For example, the NA of the objective lens 16 is 0.25. The objective lens 16 is arranged directly above the dichroic mirror 15.

The objective lens 16 focuses the illumination light L1 onto the sample 20. The objective lens 16 is arranged directly below the sample 20. Due to the homogenizing optical system 11, the illumination light L1 achieves a uniform spatial distribution across the entire FOV. The sample 20 is a cell or the like placed in a cell incubator 21. The cell incubator 21 is placed on a sample stage 22. The sample stage 22 is an xyzαβ five-axis drive stage. The symbol α represents an angle around the x-axis and the symbol β an angle around the y-axis. By driving the sample 20, the sample stage 22 can change an observation position. When the sample 20 is irradiated with the illumination light L1, fluorescence is generated from the sample 20.

The fluorescence generated from the sample 20 is incident on the objective lens 16. The fluorescence incident on the objective lens 16 becomes signal light L2 and is incident on the dichroic mirror 15. The dichroic mirror 15 causes the signal light L2 and the illumination light L1 to branch according to wavelength. Therefore, the signal light L2 is transmitted through the dichroic mirror 15 and is incident on the tube lens 31. The tube lens 31 forms an image of the sample 20 on the camera 32. In addition, a filter 33 is arranged between the camera 32 and the tube lens 31. The filter 33 is a 2-inch dual-bandpass fluorescent filter. The filter 33 blocks light at the excitation wavelength.

In the lens system 30 using the objective lens 16 and the tube lens 31, an image of the sample 20 is formed at a magnification of 2×. The magnification of the lens system 30 is preferably a low magnification of 4× or lower. In addition, the NA of the objective lens 16 is 0.25. The tube lens 31 is an imaging lens that forms a primary image of the sample 20 and has an NA of 0.125. A divisor obtained by dividing the NA of the objective lens 16 (in this case, 0.25) by the magnification of the lens system 30 (in this case, 2×) is a sensor-side NA (also referred to as an image-side NA). The sensor-side NA in this case is 0.125. If the NA of the objective lens 16 is 0.25 and the magnification of the lens system 30 is 4×, then the sensor-side NA is 0.0625. If the NA of the objective lens 16 is 0.2 and the magnification is 4×, then the sensor-side NA is 0.05. Here, the sensor-side NA is preferably greater than or equal to 0.05 and more preferably greater than or equal to 0.1. By doing so, a wide field of view can be captured while maintaining high spatial resolution.

For example, when NA is lowered, sufficient spatial resolution can no longer be obtained. In addition, when magnification is increased, a sufficiently wide field of view can no longer be obtained. Therefore, a wide field of view can be captured at high spatial resolution by setting the divisor obtained by dividing the NA by the magnification to an appropriate range.

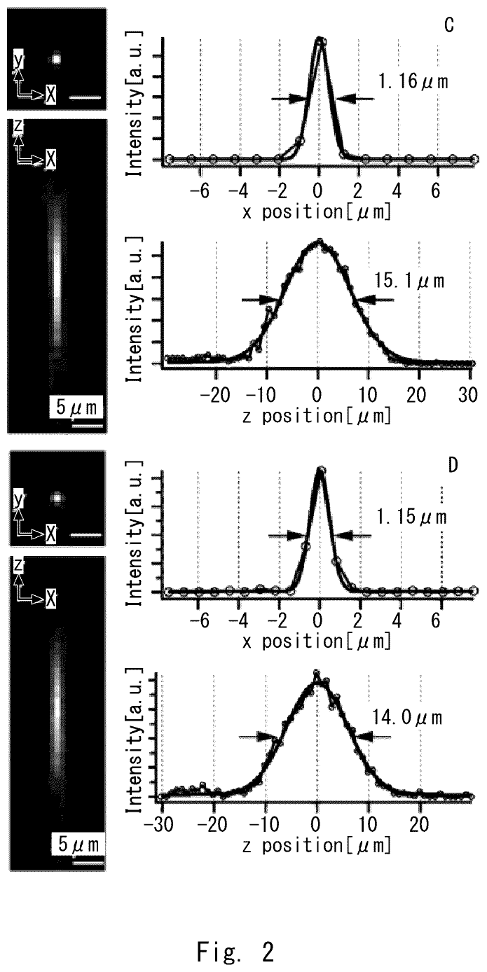

FIG. 2 is a diagram showing an evaluation result of a point spread function (PSF) of the imaging apparatus 100. FIG. 2 represents a result of experimentally obtaining the point spread function using green fluorescent beads with a diameter of 0.2 μm. A measurement result C shown at the top of FIG. 2 indicates data captured by the 120-megapixel camera. A measurement result D shown at the bottom of FIG. 2 indicates data captured by the 250-megapixel camera. In the measurement results C and D in FIG. 2, point spread functions on the xy plane and the xz plane are shown on the left side. In the measurement results C and D in FIG. 2, line profiles of the point spread functions in the x-direction and the z-direction are shown on the right side.

Spatial resolution is evaluated using the full width at half maximum of the point spread function calculated by fitting the line profile with a Gaussian function. In the case of the 120-megapixel camera, the spatial resolution is 1.16 μm (xy). In the case of the 250-megapixel camera, the spatial resolution is also approximately 1.15 μm (xy). The spatial resolution on the xy plane has been significantly improved, approximately doubling that of the previous version (AMATERAS1.0 or AMATERAS−1). However, due to the coarse sampling intervals (under-sampling) in the case of the 120-megapixel camera, if a center of a bead is located near a boundary of adjacent pixels, apparent spatial resolution declines. Coarse sampling even introduces uncertainty into an estimated position of center coordinates of the bead which varies depending on relative positions between the bead and the pixels. This poses a slight problem in situations where a shape needs to be quantitatively evaluated or when observing cells which are only a few microns in size such as E. coli.

However, this does not pose a practical problem when imaging at subcellular-level spatial resolution. In the case of the 250-megapixel camera, nearly constant resolution is achieved. In actual research settings, the 250-megapixel camera is selected when high-resolution images are required, and in other cases (such as when increasing the number of photons per pixel, reducing data size, or needing a high frame rate), the 120-megapixel camera is selected.

When the depth of field (DOF) was similarly evaluated in the z-direction using Gaussian fitting of the line profiles, the results showed a DOF of 15.1 μm for the 120-megapixel camera and 14.0 μm for the 250-megapixel camera. This difference in DOF is conceivably due to the difference in pixel size between the cameras.

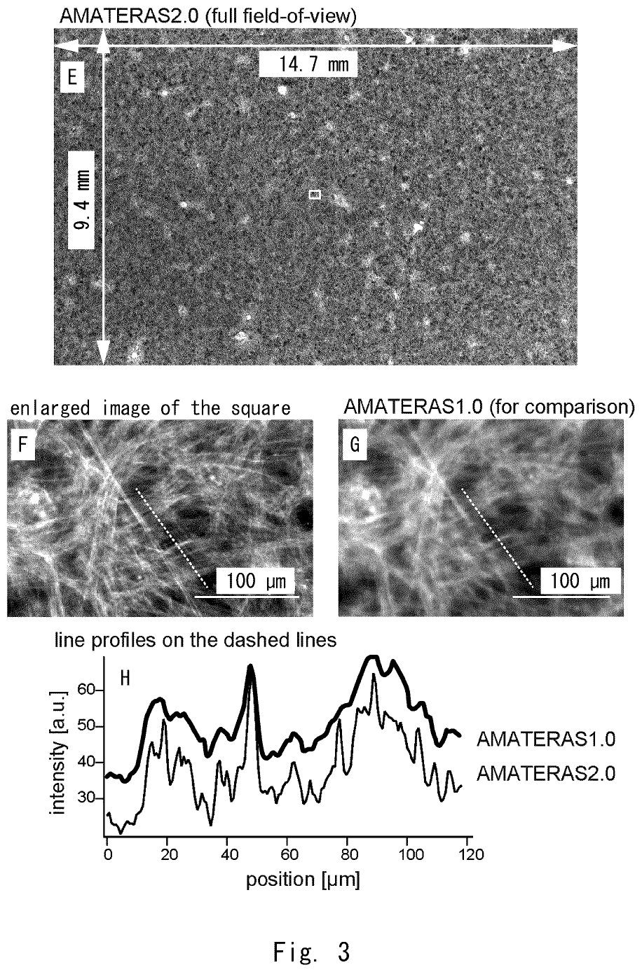

FIG. 3 shows a fluorescence image of cardiomyocytes stained with rhodamine phalloidin. In FIG. 3, image E is a captured image of the entire FOV while image F is a captured image of a part of the FOV being a captured image of a local region indicated by a white frame in image E. The images E and F in FIG. 3 are captured images obtained using the 250-megapixel camera. The size of the FOV is 14.7×9.4 mm². Image G in FIG. 3 is a diagram showing an image of the local region captured by the previous version (AMATERAS1.0 or AMATERAS−1) for comparison. Graph H in FIG. 3 shows respective line profiles. In FIG. F, a filamentous structure of F-actin stained with rhodamine is resolved with finer spatial detail.

Since the imaging apparatus 100 shown in FIG. 1 adopts wide-field illumination and detection, an image of a specific z-plane cannot be selectively acquired. Therefore, in the present embodiment, three-dimensional imaging capability is achieved using an optical sectioning method.

As optical sectioning methods, there are several existing methods applicable to visible-wavelength fluorescence imaging. Such methods include a laser scanning confocal microscope, a light sheet microscope, a light field microscope, and spatiotemporal light focusing. Among these options, the present embodiment adopts confocal imaging method. With the light sheet method, it is difficult to uniformly illuminate regions larger than or equal to 1 cm. In addition, the light field method requires sacrificing spatial resolution in exchange for resolving three dimensions in a single shot. Spatiotemporal light focusing is not suitable for the lenses described above because the use of high-output near-infrared ultrashort pulse lasers is required. In consideration thereof, as a method well-suited to a wide-field illumination and detection imaging system, the present embodiment adopts a confocal system, particularly, a multi-focus confocal system (multi confocal system) in order to cover extensive FOVs.

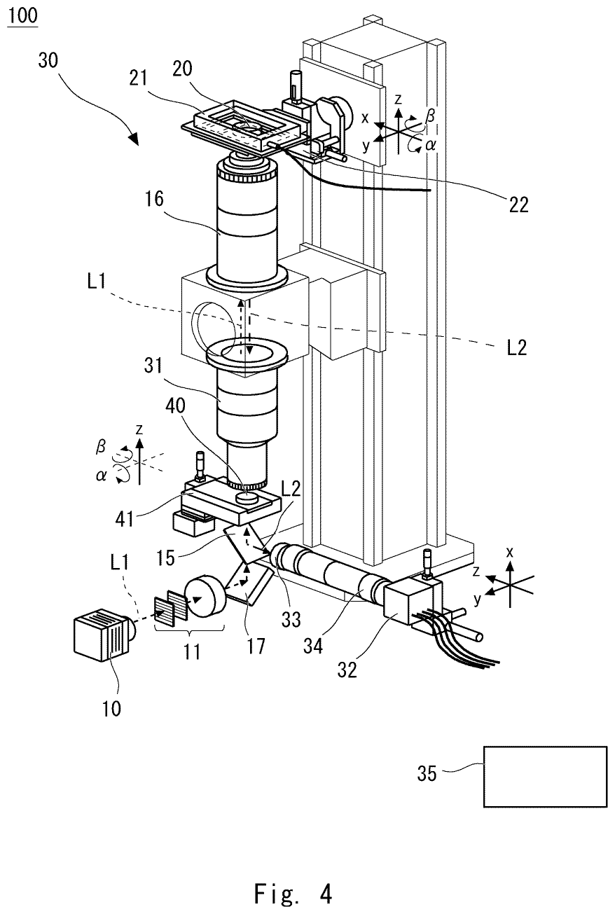

A configuration of the confocal imaging apparatus 100 will be described with reference to FIG. 4. FIG. 4 is a diagram schematically showing an overall configuration of the imaging apparatus 100. The imaging apparatus 100 is a confocal imaging apparatus using a multi-pinhole. Specifically, a multi-pinhole plate 40 provided with a plurality of pinholes is arranged within an optical path of the illumination light L1. Accordingly, the illumination light L1 forms multiple focal points on the sample 20. Note that, in the following description, descriptions of components similar to those in FIG. 1 will be omitted as appropriate. For example, the components of the lens system 30 are similar to those in FIG. 1.

The light source 10 generates the illumination light L1. The light source 10 is a high-brightness LED as described above. Obviously, the light source 10 is not limited to an LED and may be a laser light source or the like. The illumination light L1 from the light source 10 is incident on the homogenizing optical system 11. The homogenizing optical system 11 has a fly-eye lens pair and a lens and homogenizes a spatial distribution of the illumination light L1. For example, the homogenizing optical system 11 homogenizes the spatial distribution of the illumination light L1 in the multi-pinhole plate 40 to be described later. The illumination light L1 from the homogenizing optical system 11 is incident on a mirror 17. The mirror 17 reflects the illumination light L1 incident from the side upward.

The illumination light L1 reflected by the mirror 17 is incident on the dichroic mirror 15. The dichroic mirror 15 is a beam splitter that causes illumination light L1 and fluorescence to branch according to wavelength. The dichroic mirror 15 has wavelength characteristics that transmit the illumination light L1.

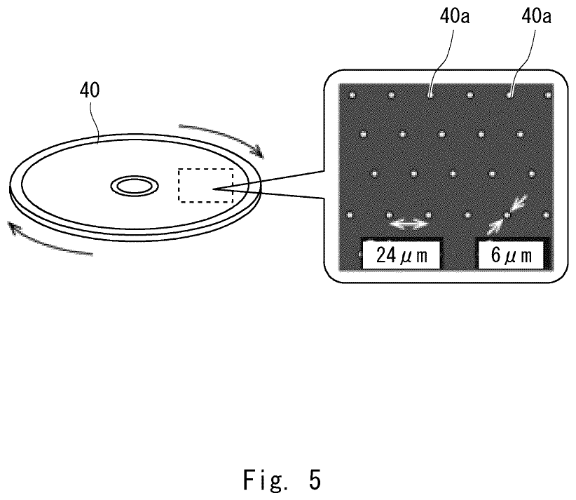

The illumination light L1 transmitted by the dichroic mirror 15 is incident on the multi-pinhole plate 40. As shown in FIG. 5, a plurality of pinholes 40a are formed on the multi-pinhole plate 40. The multi-pinhole plate 40 is arranged at a position conjugate to the sample 20. Therefore, the illumination light L1 having passed through the plurality of pinholes 40a form multiple focal points on the sample 20. In the present embodiment, the imaging apparatus 100 forms multiple focal points on the sample 20 using multi-pinholes.

Reducing the pinhole diameter improves confocal performance (resolution) but reduces the light transmittance through the multi-pinhole plate 40. Increasing the pinhole diameter improves the light transmittance through the multi-pinhole plate 40 but reduces confocal performance (resolution). In this case, as shown in FIG. 5, the diameter of each pinhole 40a is 6 μm. Obviously, the diameter of the pinholes 40a is not limited to the value described above. Results obtained using the pinholes 40a of various diameters indicate that the diameter of the pinholes 40a is preferably set to 15 μm or less and more preferably set to 12 μm or less.

In addition, the plurality of pinholes 40a are arranged in a spiral pattern at intervals. Optimal pinhole intervals depend on the brightness and distribution of fluorescent molecules within the sample. In this case, as shown in FIG. 5, the plurality of pinholes 40a are arrayed in a 24 μm pitch. Obviously, the pitch of the pinholes 40a is not limited to the value described above. For example, the pitch of the pinholes 40a is preferably set to 50 μm or less and more preferably set to 30 μm or less.

The multi-pinhole plate 40 is a disk (rotating disk) that is rotated by a drive mechanism 41. For example, the drive mechanism 41 is provided with a rotary motor that rotates the multi-pinhole plate 40. The multi-pinhole plate 40 is a circular turntable whose center serves as a rotational axis of the drive mechanism 41. The rotational axis is parallel to the optical axis and is offset from the optical axis on the xy plane. The drive mechanism 41 rotationally drives the multi-pinhole plate 40 at a constant rotational speed. Accordingly, positions of the multiple focal points on the sample 20 change. Therefore, the sample 20 can be scanned with the illumination light L1 and the sample 20 can be captured. The multi-pinhole plate 40 may be mounted to a zαβ three-axis drive stage.

The illumination light L1 having passed through the multi-pinhole plate 40 is incident on the tube lens 31. For example, the NA of the tube lens 31 is 0.125. The illumination light L1 from the tube lens 31 is incident on the objective lens 16. The objective lens 16 focuses the illumination light L1 on the sample 20. The sample 20 is a cell or the like held inside the cell incubator 21. In addition, the cell incubator 21 is mounted to the sample stage 22. The sample stage 22 has a drive mechanism that changes a position of the sample 20. For example, the sample stage 22 is an xyzαβ five-axis drive stage.

Fluorescence is generated when a fluorescent substance in the sample 20 is excited by the illumination light L1. The fluorescence from the sample 20 is incident on the objective lens 16 as signal light L2. For example, the NA of the objective lens 16 is 0.25. The signal light L2 refracted by the objective lens 16 is incident on the tube lens 31. The multi-pinhole plate 40 is arranged at an image plane of the tube lens 31. Therefore, the tube lens 31 forms an image of the sample 20 on the multi-pinhole plate 40. The signal light having passed through the pinholes 40a of the multi-pinhole plate 40 is incident on the dichroic mirror 15. The dichroic mirror 15 is arranged directly below the multi-pinhole plate 40.

The dichroic mirror 15 causes an optical path of the illumination light L1 and an optical path of the signal light L2 to branch according to a difference in wavelength. The signal light L2 is reflected toward a relay lens 34 by the dichroic mirror 15. The signal light L2 reflected by the dichroic mirror 15 is incident on the filter 33. The filter 33 is a wavelength filter that transmits light at a fluorescence wavelength while blocking light at an excitation light wavelength. For example, the filter 33 is a 2-inch bandpass fluorescent filter (#86-992, Edmund Optics).

The dichroic mirror 15 may be a short-pass dichroic mirror having a cutoff wavelength between the illumination light L1 and the signal light L2. Using a short-pass dichroic mirror enables image distortion caused by the signal light to be suppressed. For example, in a configuration where a dichroic mirror is positioned between the multi-pinhole plate 40 and the relay lens 34, using a long-pass dichroic mirror may cause image distortion when the signal light spreading from the pinholes 40a transmits through a glass plate positioned at 45° relative to the optical axis. Therefore, the dichroic mirror 15 is configured as a short-pass type to detect the signal light reflected by the dichroic mirror 15. Accordingly, image distortion can be suppressed.

The signal light L2 transmitted through the filter 33 is incident on the relay lens 34. The relay lens 34 is a telecentric lens that forms a confocal image of the sample 20 on the camera 32. For example, the relay lens 34 is a telecentric macro lens (LSTL10H-F, Myutron Inc.) with a magnification of 1×. When the relay lens 34 has a magnification of 1× and the lens system 30 has a magnification of 2×, a total magnification is 2×. Replacing the relay lens 34 with a 2× magnification lens (LSTL20H-F, Myutron Inc.) enables the total magnification to be switched from 2× to 4×. Such an optical system enables the sample 20 to be captured at a low magnification of 2× or lower or 4× or lower. In addition, when the magnification of the lens system 30 is 4×, the sample 20 can be captured at a total magnification of 4× or lower or 8× or lower.

The camera 32 is an image sensor device such as a CMOS sensor and has a plurality of pixels arranged in an array. For example, as the camera 32, either a 120-megapixel camera or a 250-megapixel camera can be used. The camera 32 outputs detected data having been detected by each pixel to the processing apparatus 35. Since the imaging apparatus 100 uses a confocal optical system with multiple focal points, pixels at positions corresponding to the multiple focal points receive the signal light L2. In addition, each pixel of the camera 32 outputs detected data indicating a brightness value of light detected by the signal light L2.

The camera 32 detects the signal light L2 while the multi-pinhole plate 40 is being rotated by the drive mechanism 41. The processing apparatus 35 generates a confocal image based on detected data from the camera 32. The processing apparatus 35 stores captured image data of the sample 20 in a memory or the like. In this manner, the processing apparatus 35 generates a confocal image of the sample 20 based on the signal light detected by the camera 32 when the multi-pinhole plate 40 is rotated. The processing apparatus 35 may control the drive mechanism 41 and the drive of the sample stage 22.

The imaging apparatus 100 is capable of capturing a confocal image of the sample 20 using the multi-pinhole plate 40. The multi-pinhole plate 40 is arranged at a position conjugate to the sample 20. In this case, the tube lens 31 forms a primary image of the sample 20 on the multi-pinhole plate 40. Furthermore, the multi-pinhole plate 40 is arranged at a plane conjugate with an image-sensor surface of the camera 32. Since scanning with the illumination light L1 is performed as the multi-pinhole plate 40 rotates, the positions of the multiple focal points on the sample 20 change. The processing apparatus 35 can generate a confocal image (tomographic image) of the sample 20 on a focal plane based on the detected data of each pixel. A focal position of the illumination light L1 in the sample 20 changes in the z-direction as the sample stage 22 moves the sample 20 in the z-direction. Accordingly, the imaging apparatus 100 can capture a plurality of tomographic images (z-stack data).

The multi-pinhole plate 40 is disposed at a plane conjugate with the sample 20. Therefore, a confocal optical system can be formed and resolution in the z-direction can be improved. The use of the multi-pinhole plate 40 enables imaging to be performed in a short period of time. The imaging apparatus 100 is not provided with a microlens array for forming multiple focal points on the sample 20. In other words, multiple focal points can be formed using only a pinhole array, without using a microlens array. In other words, the imaging apparatus 100 forms multiple focal points on the sample 20 without using a microlens array.

In general multi-focus confocal microscopes, a method combining a microlens array disk and a multi-pinhole disk is the mainstream approach. However, it is difficult to apply this method to optical systems with low magnification and high NA. This is due to the fact that the NA of the tube lens 31 is 0.125, which is significantly larger than an ordinary microscope. In other words, in order to achieve the same NA on a microlens as that on the tube lens, it is necessary either to increase the size of the microlens or to shorten the distance between the microlens array disk and the multi-pinhole disk. However, since a dichroic mirror must be arranged between the disks and the dichroic mirror needs to be significantly larger than usual in order to cover the wide field of view, it is impossible to shorten the distance between disks. One method for increasing the NA of a microlens array is to make the microlenses larger. However, doing so reduces the number of microlenses or, in other words, the number of focal points transferred onto the sample, making it impossible to uniformly illuminate the wide field of view.

Therefore, in the present embodiment, no microlenses are used to form multiple focal points and only the pinhole array is used alone. This method is rather more classical compared to methods using microlenses, and while light utilization efficiency is lower due to the absence of microlenses, the issues described above can be avoided. Therefore, the method is suitable for high NA/low magnification imaging apparatuses. While confocal systems using microlens array disks are commercially available, the diameter of multi-pinhole disks used in general microscopes is tens of μm, and the pinhole intervals are hundreds of μm. For example, CSU-X manufactured by Yokogawa Electric Corporation has a pinhole diameter of 50 μm and pinhole intervals are 250 μm.

Considering the magnification (2×) and the NA (0.25) of the imaging apparatus 100, the pinhole size must be reduced. Therefore, the pinhole size is set to 6 μm. A 6 μm pinhole is scaled down and projected onto the sample at the size of 3 μm. This size is slightly larger than a diameter of an Airy disk at excitation light wavelengths (up to 470 nm) for green fluorescent protein (GFP) and the like as well as excitation light wavelengths (up to 570 nm) for red fluorescent protein (RFP) and the like. For example, the Airy disk diameter in the sample 20 with an excitation light wavelength of 470 nm is 2.29 μm (=1.22×0.47/0.25). In addition, the Airy disk diameter in a sample with an excitation light wavelength of 570 nm is 2.78 μm (=1.22×0.57/0.25).

Since a spread of the excitation light due to diffraction at the pinhole 40a is equal to or less than the NA (0.125) of the tube lens, the PSF of the excitation light optical system (outward path from the pinhole 40a to the sample) must account for the spread caused by diffraction at the pinhole 40a. The PSF of the signal light optical system (inward path from sample to pinhole) is a convolution integral of a point source PSF and the pinhole. A total PSF of the imaging apparatus 100 is a product of PSFs of the outward path and the inward path. Furthermore, since the excitation light is uniformly distributed on the multi-pinhole plate 40 by the homogenizing optical system 11, the excitation light is constituted of a plurality of plane waves in which incident light on the pinhole 40a has a different angle.

The Airy disk diameter on the multi-pinhole plate 40 with an excitation light wavelength of 510 nm is 4.98 μm (=1.22×0.51/0.125). The Airy disk diameter on the multi-pinhole plate 40 with an excitation light wavelength of 600 nm is 5.86 μm (=1.22×0.60/0.125). If the pinhole diameter is even smaller, confocal performance improves but transmittance declines; if even larger, transmittance increases but confocal performance declines. In addition, optimal pinhole intervals depend on the brightness and distribution of fluorescent molecules within the sample. In the present embodiment, the pinhole intervals are set to 24 μm. For example, the pinhole intervals are preferably set to 50 μm or less and more preferably set to 30 μm or less.

The multi-pinhole plate 40 is arranged directly below the tube lens 31. In other words, the multi-pinhole plate 40 is arranged immediately after the tube lens 31. By doing so, an arrangement in which a distance between the tube lens 31 and the multi-pinhole plate 40 is reduced can be achieved. In addition, in the optical system that detects the signal light L2 from the sample 20, the objective lens 16, the tube lens 31, the multi-pinhole plate 40, and the dichroic mirror 15 are arranged in this order. Furthermore, the signal light L2 caused to branch by the dichroic mirror 15 is incident on the camera 32 via the relay lens 34 that is a telecentric lens. In other words, the relay lens 34 forms an image of the multi-pinhole plate 40 on the camera 32. This configuration enables the sample 20 to be appropriately captured across a wide field of view.

In addition, the magnification of the relay lens 34 is 1× or 2×. When the diameter of the pinhole 40a is equal to or less than 15 μm and the magnification of the relay lens 34 is 1×, a projected size of the pinhole 40a in the camera 32 is equal or less than 15 μm. When the diameter of the pinhole 40a is equal to or less than 15 μm and the magnification of the relay lens 34 is 2×, the projected size of the pinhole 40a in the camera 32 is equal or less than 30 μm. By doing so, sufficient light intensity can be detected at each pixel and the sample 20 can be appropriately captured with high spatial resolution.

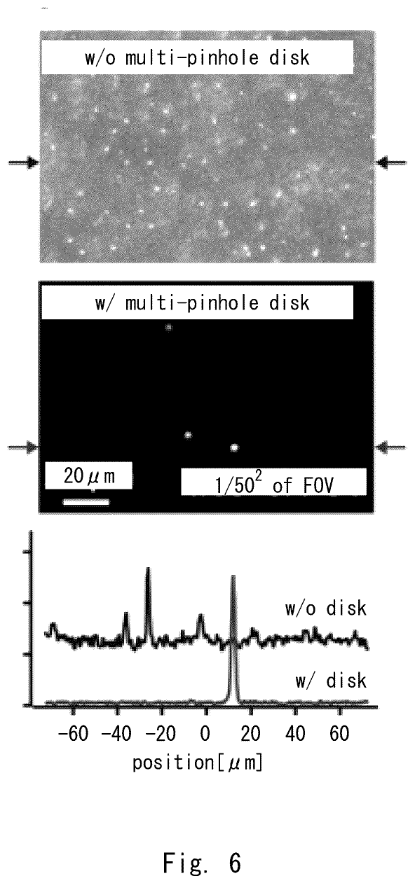

FIG. 6 is a diagram showing an imaging result by the imaging apparatus 100. A sample in which 0.5 μm fluorescent beads are dispersed three-dimensionally within an agarose gel is used. Here, an image of a region measuring 292 μm×202 μm, equivalent to 1/50² of the entire FOV, is shown. A top portion shows a captured image obtained without the multi-pinhole plate 40. A middle portion shows a captured image obtained with the multi-pinhole plate 40. A bottom portion shows respective line profiles thereof. Using the multi-pinhole plate 40 dramatically suppresses background light from outside the focal plane. This demonstrates that optical sectioning is possible using the multi-pinhole plate 40. The imaging apparatus 100 can appropriately capture images with a wide field of view.

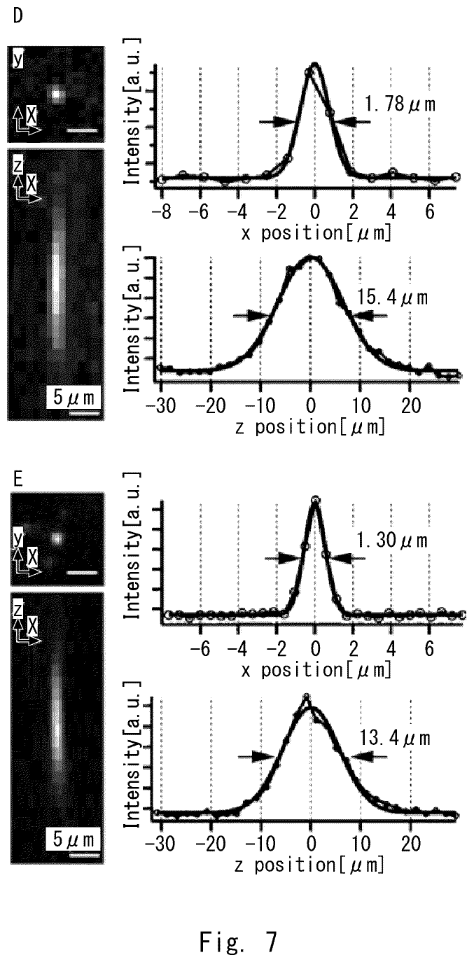

FIG. 7 is a diagram showing an evaluation result of the point spread function (PSF). A upper graph of FIG. 7 shows a measurement result D when using the relay lens 34 with a magnification of 1×, while a lower graph shows a measurement result E when using the relay lens 34 with a magnification of 2× and an NA of 0.12. The relay lens 34 with a magnification of 1× has an NA of 0.079. The relay lens 34 with a magnification of 2× has an NA of 0.12.

The NA of the relay lens 34 with a magnification of 1× is lower than the NA of the tube lens 31 (NA=0.125). Therefore, it can be seen that the spatial resolution in a lateral direction is reduced compared to the captured images obtained without the relay lens 34 (measurement results C and D in FIG. 2). On the other hand, the relay lens with a magnification of 2× (NA=0.12) has an NA nearly equivalent to that of the tube lens, resulting in a relatively small decrease in the spatial resolution in the lateral direction.

Next, three-dimensional imaging by computational sectioning will be described. In the imaging apparatus 100 shown in FIG. 4, a focal position is scanned in the z-direction and the processing apparatus 35 retrieves a two dimensional image at each z-position. Accordingly, a plurality of tomographic images or, in other words, z-stack data can be obtained. The imaging apparatus 100 captures a plurality of tomographic images by changing the focal position in the z-direction. The processing apparatus 35 removes the background light component by applying image processing to the image data acquired by the camera 32. Specifically, the processing apparatus 35 separates a signal from the focal plane from a signal from outside the focal plane through calculation.

An image before removing a background light component is considered a captured image. The captured image is a superposition of an image of an object within the focal plane and an image of an object outside the focal plane. In the captured image data, it is assumed that a spatial frequency of fluorescence images from within the focal plane is high while a spatial frequency of fluorescence images from outside the focal plane is low. The processing apparatus 35 estimates contributions from outside the focal plane as a baseline by iterative low-pass filtering. An image from within the focal plane is obtained by subtracting the baseline image from the captured image. The baseline image is two-dimensional data indicating a background light component from outside the focal plane. The processing apparatus 35 performs this calculation for each layer of the z-stack and reconstructs the data as a three-dimensional image.

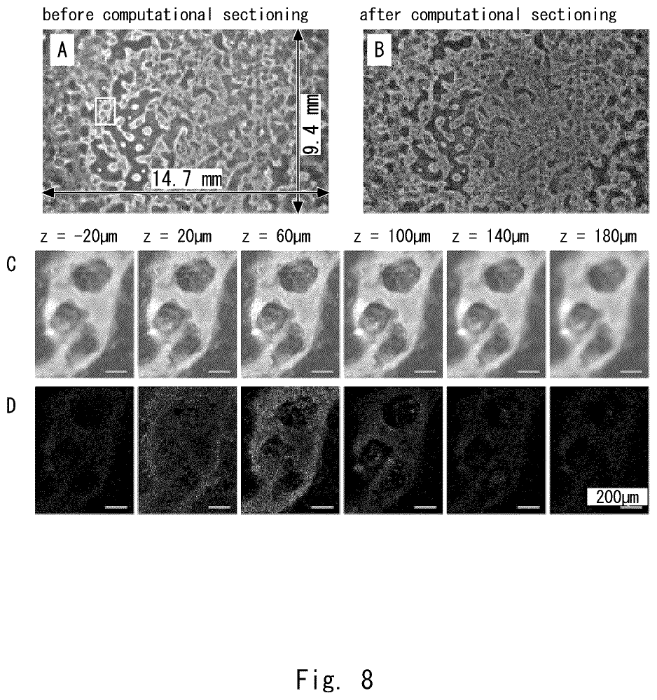

FIG. 8 shows an image from which a background light component has been removed by sectioning computation. FIG. 8 shows images of a cavity chamber structure of a cardiac organoid. The organoid is a three-dimensional organoid that has been extensively studied in recent years in developmental biology and regenerative medicine, and is known as a model for human myocardial histogenesis. A large-area organoid is created across the entire FOV and chemically fixed. Troponin was immunostained, and nuclei were stained with Hoechst.

A maximum height of the organoid is approximately 150 μm. The z-stack data was obtained by repetitively photographing a three-dimensional region containing the organoid by scanning the three-dimensional region in 4 μm-steps in the z-direction. Image A and image B in FIG. 8 are images of the organoid across the entire FOV, respectively.

In FIG. 8, image A is a captured image before processing of computational sectioning and image B is a processed image after processing of computational sectioning. Both images A and B represent maximum intensity projection images of the z-stack. In all z planes, strong background light was superimposed before computational processing, but after computational processing, the three-dimensional distribution of the nuclei was clearly visualized.

Image C is an image of a local region indicated by a dashed frame in image A, and image D is an image of a local region indicated by a white line frame in image B.

Images C and D represent tomographic images when the z-position is changed in 40 μm-intervals, respectively.

As a result, it is evident that the organoid has a cavity chamber structure. This result demonstrates that the present method is effective for wide-field 3D imaging.

In principle, if the signal-to-baseline ratio is sufficiently higher than bit depth, a focal plane component on the baseline can be extracted using the above calculation. This method requires that the spatial frequency of the fluorescence image within the focal plane is significantly higher than that of the image outside the focal plane. In actual cell imaging, this method is effective when fluorescent molecules are localized within the cell such as the nucleus or when the fluorescent molecules have filamentous structures. On the other hand, caution is required for distributions with spatially uniform intensity, as they tend to produce results that emphasize edge regions.

Hereinafter, a specific example of sectioning processing in the processing apparatus 35 will be described. The processing apparatus 35 estimates a background light component using a low-pass filter. Specifically, the processing apparatus 35 removes the background light component by performing iterative calculations for filter processing using a low-pass filter as follows.

Here, let f₀(x, y) denote image data captured by the camera 32. The image data f₀(x, y) is two-dimensional image data and a brightness value is set for each xy coordinate. The processing apparatus 35 calculates curved surface data L₀(x, y) of a smooth curved surface by applying a low-pass filter to the image data f₀(x, y). The curved surface data L₀(x, y) is a low-frequency component contained in the image data f₀(x, y) and, specifically, represents a background light component. In other words, the processing apparatus 35 extracts the low-frequency component of the image data f₀(x, y) as the background light component.

The processing apparatus 35 takes a smaller value between f₀(x, y) and L₀(x, y) at each coordinate and sets whichever is smaller as f₁(x, y). The processing apparatus 35 applies the same processing to f₁(x, y) to obtain f₂(x, y). In other words, the processing apparatus 35 generates L₁(x, y) by applying a low-pass filter to f₁(x, y). The processing apparatus 35 takes a smaller value between f₁(x, y) and L₁(x, y) at each coordinate and sets whichever is smaller as f₂(x, y). The processing apparatus 35 performs iterative calculations according to equation (1) below.

[Mathematical Formula 3]

fⱼ(x, y)=min(fⱼ₋₁(x, y), Lⱼ₋₁(x, y) (1)

In equation (1), min(a, b) is a function that returns whichever is smaller of values a and b, and j denotes an integer greater than or equal to 1. The processing apparatus 35 increments j from 1 through the iterative calculations of equation (1). Image data Lⱼ₋₁(x, y) is image data obtained by applying a low-pass filter to image data fⱼ₋₁(x, y). Due to the iterative calculations, fⱼ(x, y) asymptotically approaches the baseline of the image data f₀(x, y). In other words, fⱼ(x, y) is image data representing the background light component. As shown in inequality (2) below, the processing apparatus 35 performs the iterative calculations of equation (1) until a standard deviation Var of a difference between fⱼ(x, y) and Lⱼ(x, y) reaches a value ε set in advance.

[Mathematical Formula 4]

{square root over (Var(fⱼ(x, y)−Lⱼ(x, y)))}<ε (2)

In addition, by applying processing using the low-pass filter to fⱼ(x, y) when the standard deviation converges to the value ε set in advance, the processing apparatus 35 calculates the image data Lⱼ(x, y) indicating the background light component. The processing apparatus 35 adopts the image data Lⱼ(x, y) as data of the baseline. The image data Lⱼ(x, y) converges to the baseline of the image data f₀(x, y) of the captured image. By subtracting the image data Lⱼ(x, y) of the baseline from the image data f₀(x, y) of the captured image, the processing apparatus 35 obtains a confocal image from which the background light component has been removed.

When an image size (number of pixels) is small, the processing apparatus 35 may perform the processing using a convolution filter such as a moving average method or a low-pass filter in Fourier space using fast Fourier transform (FFT). Note that since processing time increases when the number of pixels is extremely large, the processing apparatus 35 uses an infinite impulse response (IIR) filter in order to accelerate processing.

The processing apparatus 35 sequentially applies a one-dimensional IIR filter in two directions (x, y) as a method of calculating a two-dimensional low-pass filter. For example, the one-dimensional IIR filter in the y-direction may be applied after applying the one dimensional IIR filter in the x-direction, or the filters may be applied in an opposite order.

This method is faster than conventional methods that use two-dimensional convolution in real space or filtering on the Fourier plane. This is particularly noticeable when the number of pixels of a single image is extremely large, as in this case. Although the low-pass filter shape is not isotropic on the Fourier plane, this does not pose a practical problem. For example, the processing apparatus 35 can use the Butterworth filter as the IIR low-pass filter.

Some or all of the processing performed by the processing apparatus 35 may be executed by a computer program. The program described above can be stored and supplied to a computer using any type of non-transitory computer readable media. Non-transitory computer readable media include any type of tangible storage media. Examples of non-transitory computer readable media include magnetic storage media (such as a floppy disk, a magnetic tape, and a hard disk drive), optical magnetic storage media (such as a magneto-optical disk), a CD-ROM (read only memory), a CD-R, a CD-R/W, and semiconductor memories (such as a mask ROM, a PROM (programmable ROM), an EPROM (erasable PROM), a flash ROM, and a RAM (random access memory)). In addition, the program may be supplied to a computer using any type of transitory computer readable media. Examples of transitory computer readable media include an electric signal, an optical signal, and electromagnetic waves. Transitory computer readable media can supply the program to a computer via a wired communication line (such as an electric wire or an optical fiber) or a wireless communication line.

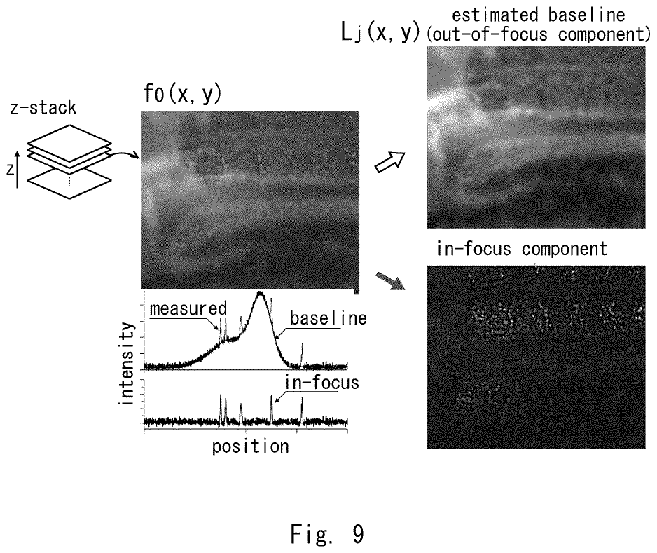

FIG. 9 is a series of images showing a processing result obtained by computational sectioning. In FIG. 9, image data f₀(x, y) of the captured image represents image data retrieved from the camera 32. Furthermore, in FIG. 9 image data Lⱼ(x, y) of an estimated baseline and image data within the focal plane (in focus) are shown in a right side of the image data f₀(x, y) of the captured image. The processing apparatus 35 calculates the image data within the focal plane by subtracting image data fⱼ(x, y) from the image data f₀(x, y).

According to the processing described above, the processing apparatus 35 separates the image data of the captured image into the image data of the baseline and the image data within the focal plane. Line profiles of the image data of the captured image, the image data of the baseline, and the image data within the focal plane are shown below the image data of the captured image (raw data). In this manner, the background light component from outside the focal plane can be removed through computational sectioning.

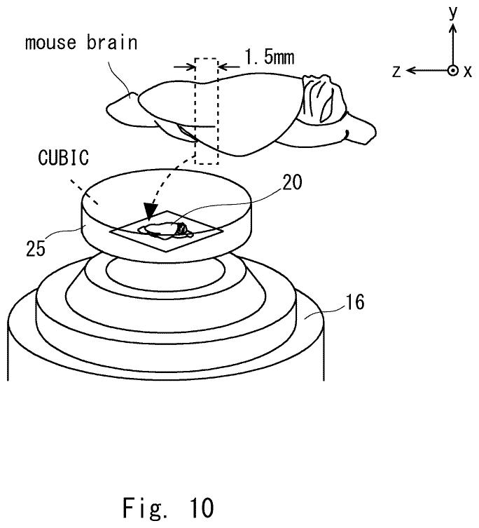

FIGS. 10 to 12 show demonstration results of three dimensional imaging obtained by optical sectioning method and computational sectioning method. As shown in FIG. 10, the sample 20 is a 1.5 mm-thick piece of a coronal plane of a mouse brain. The piece was placed on a transparent glass container 25. The mouse brain was chemically cleared using a tissue clearing reagent CUBIC and the cell nuclei were specifically stained with SYTOX-Green. The relay lens 34 with a magnification of 1× was adopted in order to cover the entire coronal plane, and the sample 20 was captured at an overall magnification of 2×.

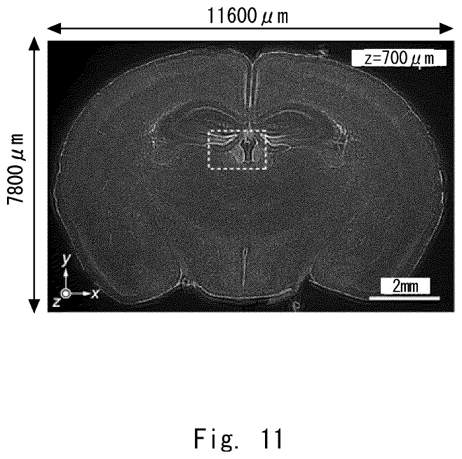

Exposure time for one z-plane was 1 second, and the sample stage 22 caused the 1.5 mm-thick sample 20 to be scanned in the z-direction at 4 μm steps. The imaging apparatus 100 acquired z-stack data of 378 layers. The imaging apparatus 100 acquired an image of the sample 20 using both optical and computational sectioning. FIG. 11 is a fluorescence image of one z-plane (z=700 μm) among the 378 layers. A cross-section measuring approximately 1.2 cm×0.8 cm on the coronal plane was clearly observed at single-cell resolution.

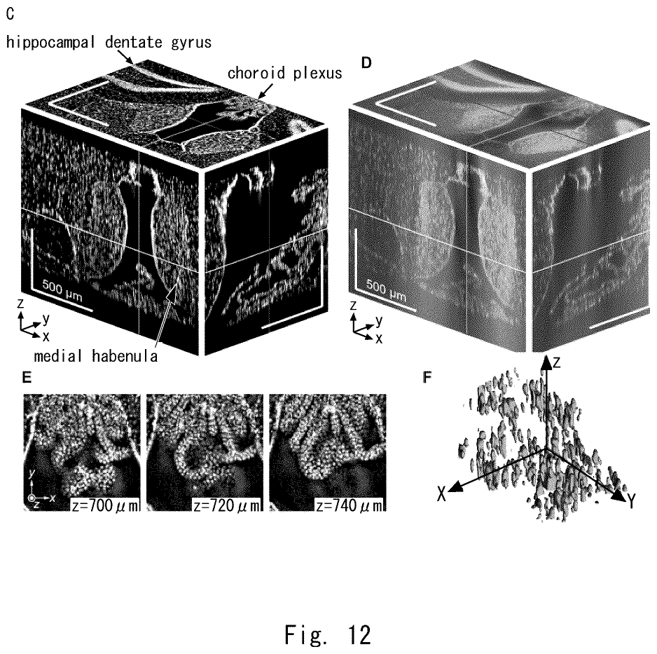

Image C in FIG. 12 represents an enlarged view of the xy plane (coronal plane) within a region in the dashed rectangular frame in FIG. 11 and sectional views of xz (transverse plane) and yz (sagittal plane). The xz sectional view and yz sectional view clearly demonstrate that acquisition of tomographic images in the z-direction has been achieved. Image C in FIG. 12 represents processed data after computational sectioning.

On the other hand, image D in FIG. 12 is a three dimensional representation prior to computational sectioning processing (raw data obtained by optical sectioning). While optical sectioning alone also enables surface-selective imaging, there is overlapping of strong background light. In particular, in regions with high cell density, the strong background light overlaps with images of surrounding regions. It was confirmed that, by removing this background light through computational processing, a high-contrast, sharp image can be obtained as represented by image C in FIG. 12.

In the 1.5 mm-thick piece, the characteristic cellular distribution of choroid plexus epithelial cells is clearly visualized in three dimensions. Image E in FIG. 12 compares images of three z-planes in an xy region that contains the choroid plexus region. Image E in FIG. 12 represents three tomographic images z=700 μm, 720 μm, and 740 μm, respectively. It is clearly demonstrated that the structure changes depending on positions in the z-direction.

Image F in FIG. 12 is an equivalent surface representation of nuclei within a 200 μm×200 μm×200 μm cube in the choroid plexus region. While individual nuclei appear elongated in the z-direction due to the low spatial resolution in the z-direction, it is evident that the nuclei are spatially separated from surrounding nuclei in three-dimensional space. In addition, the three dimensional structures of hippocampal dentate gyrus granule cells and the medial habenular nuclei, which are known to be associated with memory formation and depression, are also clearly visualized (image C in FIG. 12).

Since the imaging apparatus 100 uses a confocal optical system, the imaging apparatus 100 is capable of removing background light even when performing imaging over a wide field of view. In addition, the resolution in the optical axis direction can be improved to 15 μm. The sample 20 can be captured across a wide field of view at a total magnification of 4× or lower.

A confocal imaging method according to the present embodiment includes the steps of: generating illumination light L1 that illuminates the sample 20; causing the illumination light L1 to be incident on the multi-pinhole plate 40 being arranged at a position conjugate to the sample 20; focusing the illumination light L1 having passed through the plurality of pinholes of the multi-pinhole plate onto the sample 20 using the objective lens 16; causing signal light from the sample 20 to be incident on the objective lens 16; focusing the signal light from the sample 20 onto the multi-pinhole plate 40 using a tube lens arranged between the objective lens 16 and the multi-pinhole plate; causing the signal light having passed through a plurality of pinholes 40a to branch from the illumination light directed toward the multi-pinhole plate using a beam splitter; focusing the signal light caused to branch by the beam splitter onto an image sensor device using a telecentric lens; driving the multi-pinhole plate so as to change an incidence position of the illumination light relative to the sample; and capturing the sample with signal light detected by the image sensor device when the multi-pinhole plate is rotated.

While an invention made by the present inventors has been described using specific terms based on an embodiment, it is to be understood that the present invention is not limited to the embodiment described above and that various changes and modifications can be made without departing from the spirit and scope of the invention.

The present application claims priority on the basis of Japanese Patent Application No. 2023-077341 filed on May 9, 2023, the entire contents of which are incorporated herein by reference.

### REFERENCE SIGNS LIST

100 IMAGING APPARATUS
10 LIGHT SOURCE
11 HOMOGENIZING OPTICAL SYSTEM
13 CONJUGATE SURFACE
14 LENS
15 DICHROIC MIRROR
16 OBJECTIVE LENS
17 MIRROR
20 SAMPLE
21 CELL INCUBATOR
22 SAMPLE STAGE
30 LENS SYSTEM
31 TUBE LENS
32 CAMERA
33 FILTER
34 RELAY LENS
35 PROCESSING APPARATUS
40 MULTI-PINHOLE PLATE
41 DRIVE MECHANISM
L1 ILLUMINATION LIGHT
L2 SIGNAL LIGHT

1. A confocal imaging apparatus, comprising:
a light source configured to generate illumination light that illuminates a sample;
a multi-pinhole plate being arranged at a position conjugate to the sample and having a plurality of pinholes through which the illumination light passes;
a drive mechanism configured to drive the multi-pinhole plate so as to change an incidence position of the illumination light relative to the sample;
an objective lens configured to focus the illumination light from the multi-pinhole plate onto the sample and on which signal light from the sample is incident;
a tube lens arranged between the objective lens and the multi-pinhole plate and configured to focus the signal light from the sample onto the multi-pinhole plate;
a beam splitter configured to cause the signal light having passed through the pinholes to branch from the illumination light directed toward the multi-pinhole plate;
a telecentric lens on which the signal light caused to branch by the beam splitter is incident; and
an image sensor device configured to detect the signal light from the telecentric lens and to capture an image of the sample.

2. The confocal imaging apparatus according to claim 1, wherein
a background light component is calculated by applying filter processing using a low-pass filter to image data captured by the image sensor device, and
the background light component is removed from the image data captured by the image sensor device.

3. The confocal imaging apparatus according to claim 2, wherein
if f₀(x, y) denotes the image data captured by the image sensor device,
curved surface data L₀(x, y) is generated by applying processing using a low-pass filter to the image data f₀(x, y),
for j an integer greater than or equal to 1, image data fⱼ(x, y) is generated by performing iterative calculations according to equation (1) below,
[Mathematical Formula 1]
fⱼ(x, y)=min(fⱼ₋₁(x, y), Lⱼ₋₁(x, y)) (1)
image data Lⱼ(x, y) indicating the background light component is generated by applying processing using the low-pass filter to the image data fⱼ(x, y), and
the background light component is removed by subtracting the image data Lⱼ(x, y) from the image data f₀(x, y) of the captured image.

4. The confocal imaging apparatus according to claim 3, wherein
the low-pass filter is a one-dimensional infinite impulse response filter, and
the background light component is calculated by sequentially applying the one-dimensional infinite impulse response filter in an xy direction.

5. The confocal imaging apparatus according to claim 1, wherein a magnification of an image of the sample formed by lens system is 2× or lower.

6. The confocal imaging apparatus according to claim 1, wherein a diameter of the pinholes is 15 μm or less.

7. A confocal imaging method, comprising the steps of:
generating illumination light that illuminates a sample;
causing the illumination light to be incident on a multi-pinhole plate disposed at a plane conjugate with the sample;
focusing the illumination light having passed through a plurality of pinholes of the multi-pinhole plate onto the sample using an objective lens;
causing signal light from the sample to be incident on the objective lens;
focusing the signal light from the sample onto the multi-pinhole plate using a tube lens arranged between the objective lens and the multi-pinhole plate;
causing the signal light having passed through the plurality of pinholes to branch from the illumination light directed toward the multi-pinhole plate using a beam splitter;
focusing the signal light caused to branch by the beam splitter onto an image sensor device using a telecentric lens;
driving the multi-pinhole plate so as to change an incidence position of the illumination light relative to the sample; and
capturing the sample with signal light detected by the image sensor device when the multi-pinhole plate is rotated.

8. The confocal imaging method according to claim 7, wherein
a background light component is calculated by applying filter processing using a low-pass filter to image data of a captured image obtained by the image sensor device, and
the background light component is removed from the image data of the captured image.

9. The confocal imaging method according to claim 8, wherein
if f₀(x, y) denotes image data of a captured image obtained by the image sensor device,
curved surface data L₀(x, y) is generated by applying processing using a low-pass filter to the image data f₀(x, y),
for j an integer greater than or equal to 1, image data fⱼ(x, y) is generated by performing iterative calculations according to equation (1) below,
[Mathematical Formula 2]
fⱼ(x, y)=min(fⱼ₋₁(x, y), Lⱼ₋₁(x, y) (1)
image data Lⱼ(x, y) indicating the background light component is generated by applying processing using the low-pass filter to the image data fⱼ(x, y), and
the background light component is removed by subtracting the image data Lⱼ(x, y) from the image data f₀(x, y) of the captured image.

10. The confocal imaging method according to claim 9, wherein
the low-pass filter is a one-dimensional infinite impulse response filter, and
the background light component is calculated by sequentially applying the one-dimensional infinite impulse response filter in an xy direction.

11. The confocal imaging method according to claim 7, wherein a magnification of an image of the sample formed by lens system is 2× or lower.

12. The confocal imaging method according to claim 7, wherein a diameter of the pinholes is 15 μm or less.
